(19) United States
(12) Patent Application Publication
(10) Pub. No.: US 2007/0177156 A1
(43) Pub. Date: Aug. 2, 2007

(54) Surface profiling method and apparatus

(76) Inventor: Daniel Mansfield, Leicester (GB)

Correspondence Address: RATNERPRESTIA, P O BOX 980, VALLEY FORGE, PA, 19482-0980, US

(21) Appl. No.: 10/565,030

(22) PCT Filed: Jul. 14, 2004
(86) PCT No.: PCT/GB04/03066

§ 371 Date: Jan. 22, 2007

(30) Foreign Application Priority Data
Jul. 18, 2003 (GB) 0316916.6

(51) Int. Cl. G01B 11/02

(52) U.S. Cl. 356/512; 356/497

(57) ABSTRACT

A surface profiling apparatus for providing surface profile information for a sample surface. This apparatus includes: support means for supporting a sample having a non-planar surface; light directing means for directing broadband light to an interference zone along first and second light paths; moving means for causing relative movement between the sample surface and a non-uniform sample light beam; and compensating means for compensating for the difference between the two path lengths caused by this relative movement. The first light path includes the sample surface and the second light path includes a non-planar reference surface. The light directing means comprises shaping means operable to shape the beams of light to form: a non-uniform reference light beam with a wavefront substantially matching the reference surface along the second light path; and the sample light beam with a beam profile substantially matching the reference light beam profile along the first light path.

This invention relates to a method of obtaining surface profile information for a sample surface and an apparatus therefor. The invention has particular, but not exclusive, relevance to obtaining surface profile information for an aspheric surface.

To date, many different optical metrology techniques have been used to obtain profile information for a sample surface. Typically, these optical metrology techniques have employed an interferometer having a monochromatic light source which emits highly coherent light, such as a laser, which is separated into two light beams, one of which (hereafter called the sample light beam) is directed to an interference zone via the sample surface and the other of which (hereafter called the reference light beam) is directed to the interference zone via a reference surface. Under certain conditions, the combination of the sample light beam and the reference light beam in the interference zone forms interference fringes indicative of phase shifts between the sample light beam and the reference light beam, and information relating to the profile of the sample surface can be obtained by detecting and processing the spatial fringe pattern.

Such conventional monochromatic interferometric surface profiling apparatuses can provide resolution in the nanometre to Angstrom range, but generally the shift in the phase difference between the sample light beam and the reference light beam for neighbouring detector elements of the detector must be less than π radians to avoid phase ambiguity. Another problem with conventional monochromatic interferometric techniques is that interference fringes can also be formed by reflections from surfaces other than the sample surface and the reference surface, thereby complicating the interpretation of the measured interference pattern. For example, if the sample is a lens and the sample surface is one surface of the lens, then interference fringes may also be formed by the combination of light reflected by the other surface of the lens and light reflected by the reference surface.

As discussed in a paper entitled “Profilometry with a coherence scanning microscope” by Byron S. Lee and Timothy C. Strand (published in Applied Optics, Vol. 29, No. 26, 10 Sep. 1990 at pages 3784 to 3788), an alternative optical metrology technique is coherence scanning or broadband scanning interferometry, which uses a broadband light source with a standard interferometer arrangement. As a result of the use of a broadband light source, one condition for an interference pattern to be observed in the interference zone is that the optical path length travelled by the sample light beam is substantially the same as the optical path length travelled by the reference light beam. During a measurement, one of the sample surface and the reference surface is moved relative to the other so that in each relative position this condition is satisfied by different portions of the sample surface. By recording for each relative position which parts of the sample surface exhibit an interference pattern, profile information for the sample surface is obtained.

By using a broadband light source, the problem of interference patterns being caused by reflections from optical surfaces other than the sample surface and the reference surface is generally removed because interference patterns are only observed for light beams which have travelled approximately equal optical path lengths. The phase ambiguity problem is also, to an extent, solved by the use of broadband scanning interferometry because the positional information relating to a localised interference pattern is measured, rather than measuring phase shifts. However, there is still a limit to the extent of variation of the profile of the sample surface from a reference profile because as this variation increases, the visibility of the interference pattern decreases and therefore becomes more and more difficult to detect.

In one aspect, the present invention provides a surface profiling apparatus in which a sample surface is moved through a sample light beam having a non-uniform beam profile (i.e. the profile of a wavefront varies along the direction of propagation of the light beam) so that at different positions of the sample surface, different regions of the sample surface substantially coincide with a wavefront of the non-planar light beam. As this movement of the sample surface causes a variation in the optical path length of the sample beam, the surface profiling apparatus includes means for compensating for differences between the optical path length travelled by the sample light beam and the reference light beam so that light from portions of the sample surface which substantially coincide with a wavefront of the sample light beam and light from corresponding portions of the reference surface produce an interference pattern in the interference zone. By moving the sample surface through the non-uniform sample light beam, in effect at each position of the sample surface the reference profile is different and therefore the range of measurement of the surface profiling apparatus is increased.

Various embodiments of the invention will now be described with reference to the accompanying Figures in which:

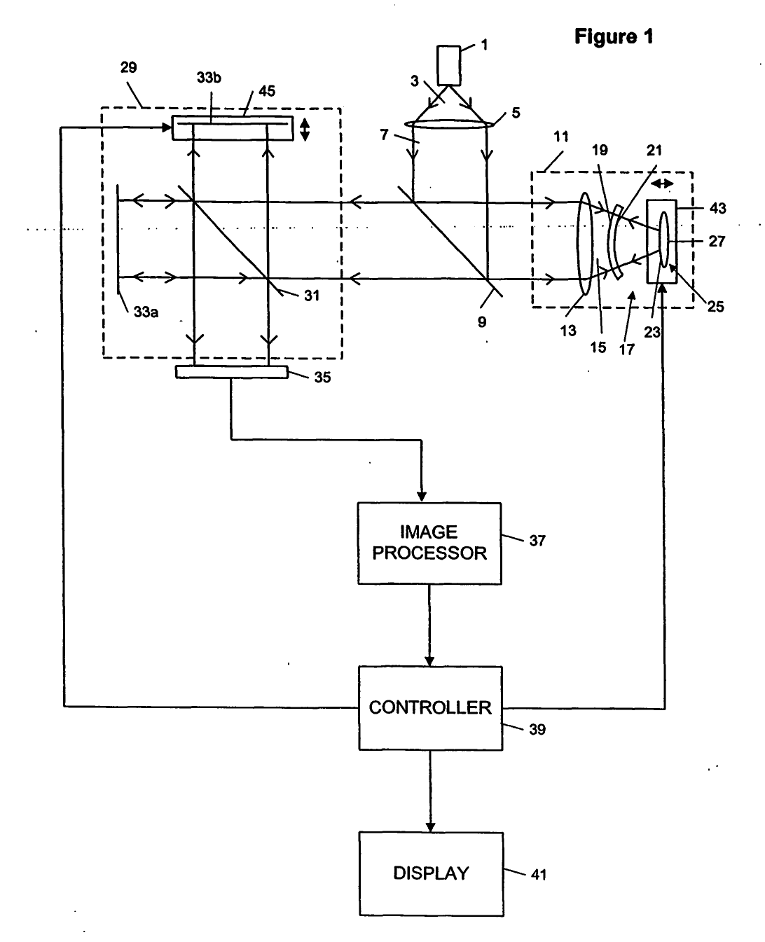

FIG. 1 schematically shows a surface profiling apparatus forming a first embodiment of the invention;

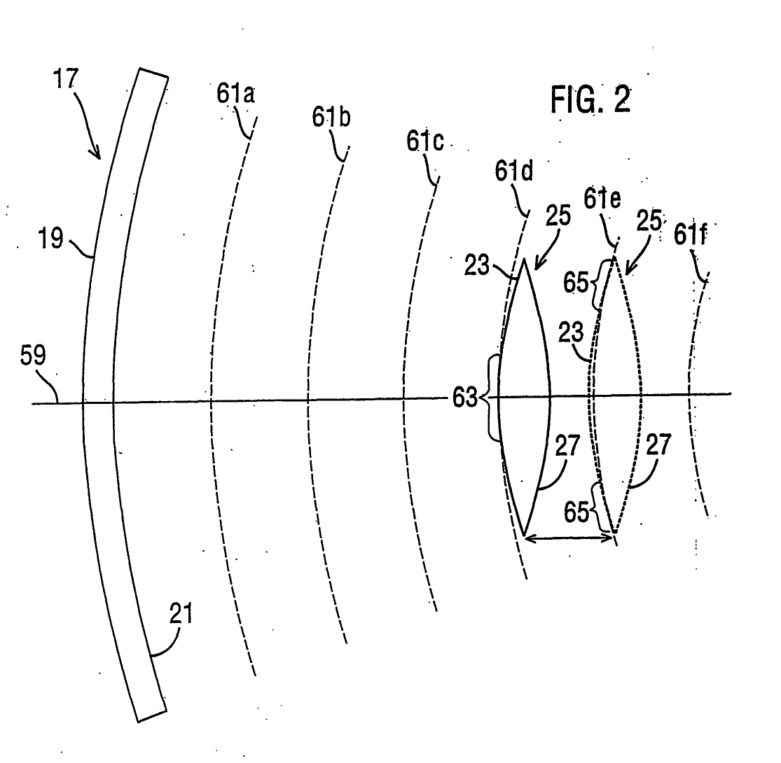

FIG. 2 schematically shows in more detail the movement of a sample surface through a non-planar light beam produced in the surface profiling apparatus illustrated in FIG. 1;

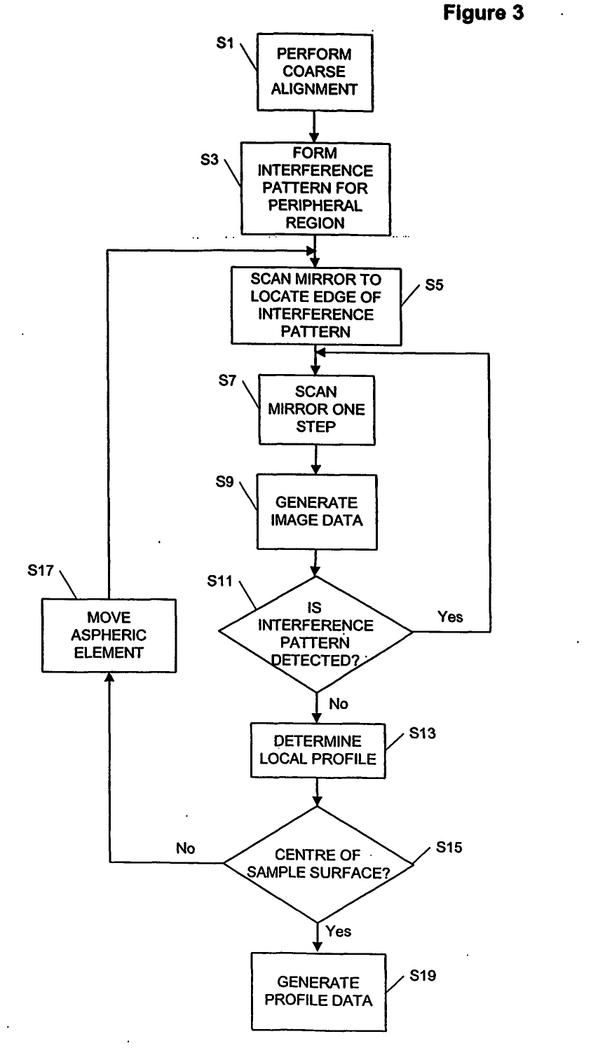

FIG. 3 is a flow chart illustrating operations performed by the surface profiling apparatus shown in FIG. 1 during use;

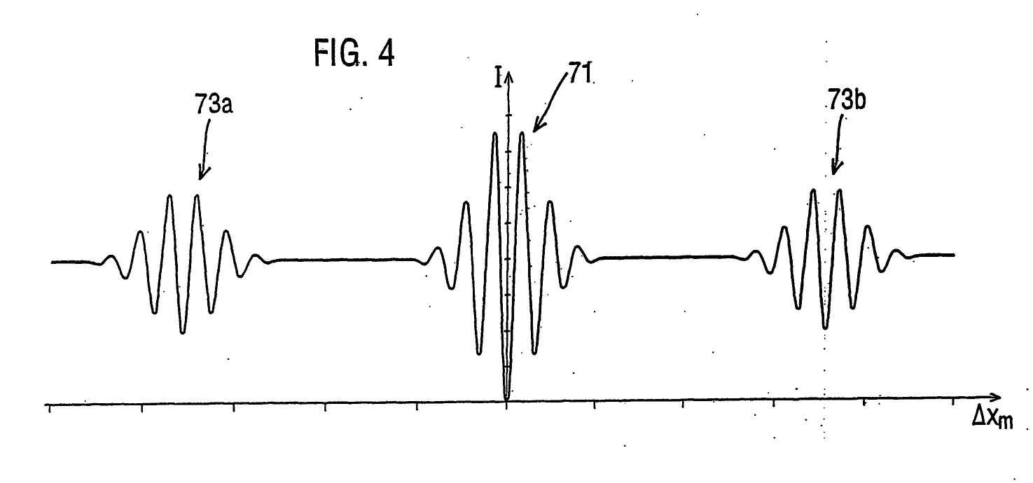

FIG. 4 is a plot schematically showing a variation in detected light intensity caused by movement of a mirror forming part of the surface profiling apparatus illustrated in FIG. 1;

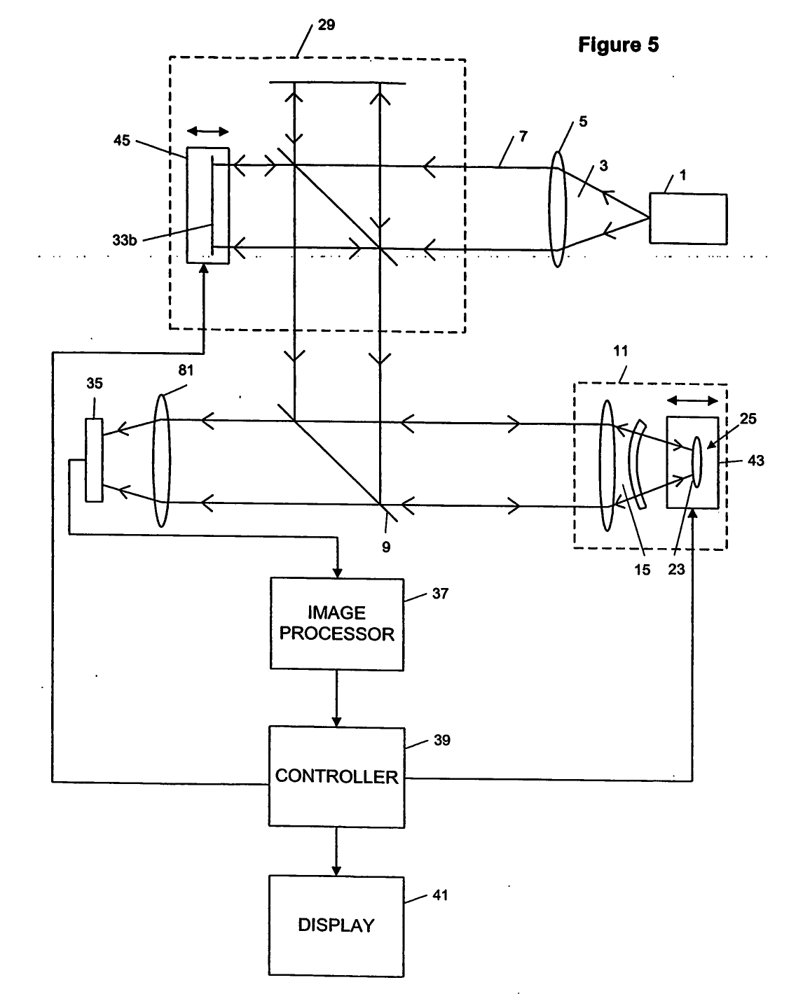

FIG. 5 schematically shows a surface profiling apparatus forming a second embodiment of the invention;

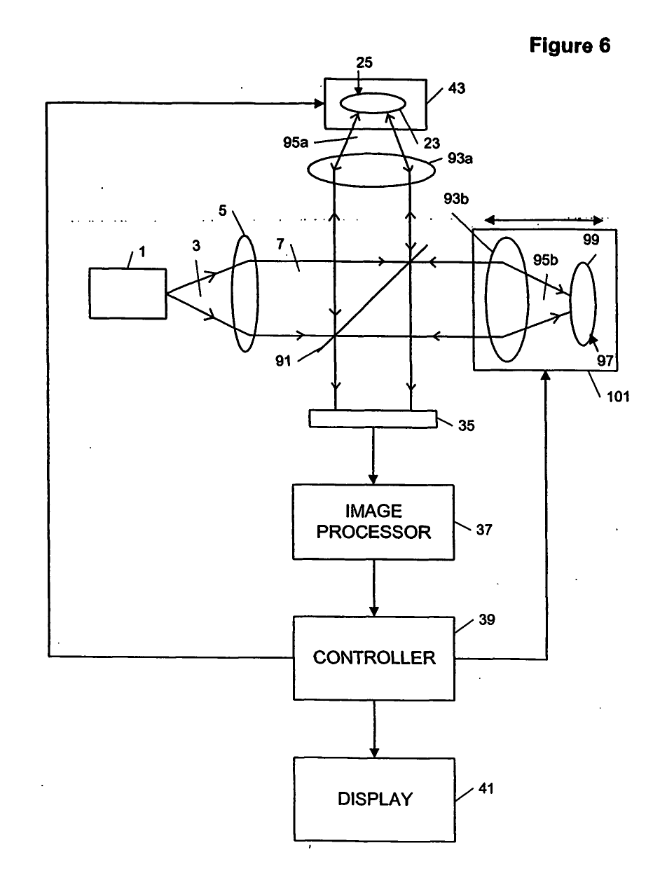

FIG. 6 schematically shows a surface profiling apparatus forming a third embodiment of the invention;

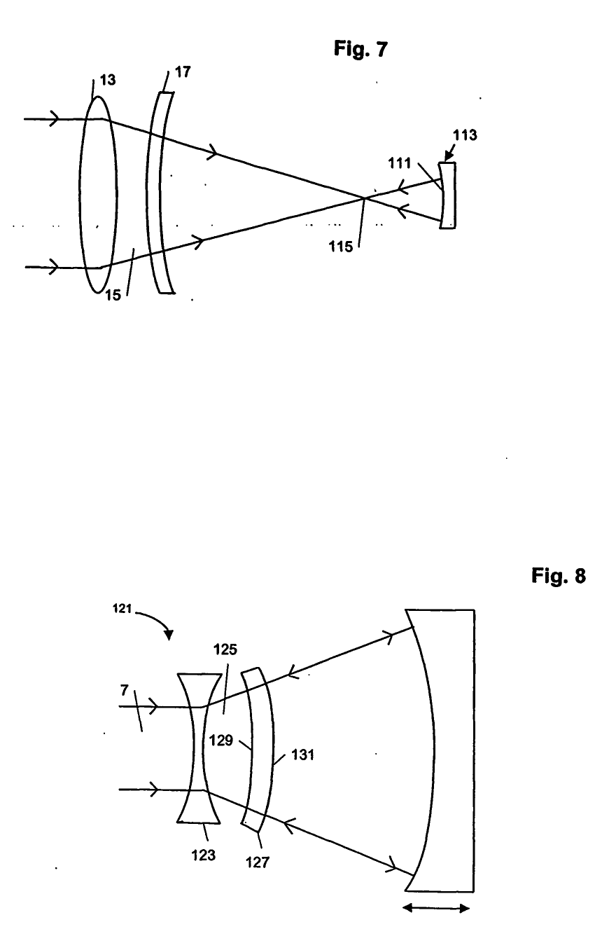

FIG. 7 schematically shows the surface profiling apparatus forming the first embodiment of the invention measuring a concave lens surface; and

FIG. 8 schematically shows a Fizeau-type interferometer forming part of a fourth embodiment of the invention.

As shown in FIG. 1, the surface profiling apparatus of the first embodiment of the invention has a light source 1 which emits a divergent light beam 3 which is collimated by a collimating lens 5 to produce a low divergence light beam 7. In this embodiment, the light source 1 is a LM2-850-1.0 pigtailed superluminescent diode, available from Volga Technology Ltd in the UK, having a centre wavelength of 850 nm and a FWHM spectral width of 10 nm.

The light beam 7 is incident on a beam splitter 9 which reflects approximately half of the intensity of the light beam 7 through an angle of 90° so that the reflected part of the light beam 7 is directed to a Fizeau-type interferometer 11, outlined by dashed lines in FIG. 1. In particular, the reflected part of the light beam 7 is incident on a converging lens 13 which produces a converging light beam, hereafter referred to as a spherical light beam 15, having part-spherical wavefronts which are centred at the focal point of the converging lens 13. In this embodiment, the surfaces of the lens elements forming the converging lens 13 are anti-reflection coated to reduce back reflections.

The spherical light beam 15 is incident on a meniscus lens 17 having a front surface 19 and a rear surface 21 which each substantially coincide with a respective wavefront of the spherical light beam 15. The front surface 19 of the meniscus lens 17 is anti-reflection coated to prevent back reflections. However, the rear surface 21, hereafter called the reference surface 21, is uncoated so that a portion of the spherical light beam 15 is reflected back on itself and re-collimated by the converging lens 13.

The portion of the spherical light beam 15 which is transmitted through the reference surface 21 is incident on the front surface here after called the sample surface 23, of an aspheric element 25, which also has a rear surface 27. The sample surface 23 is the surface whose profile is interrogated by the surface profiling apparatus. Where a region of the sample surface 23 of the aspheric element 25 substantially coincides with a wavefront of the spherical light beam 15, some of the light of the spherical light beam 15 is reflected back on itself, passes back through the meniscus lens 17 and is re-collimated by the converging lens 13. In this way, a reference light beam is formed by light from the light source 1 which is reflected from the reference surface 21 and a sample light beam is formed by light from the light source 1 which is reflected from the sample surface 23. The path difference Δx_{F} between the distances travelled by the reference light beam and the sample light beam within the Fizeau-type interferometer 11 is twice the distance between the reference surface 21 and the sample surface 23.

The reference light beam and the sample light beam are incident on the beam splitter 9, which transmits half of the reference light beam and half of the sample light beam towards a Michelson-type interferometer 29, outlined by dashed lines in FIG. 1. The Michelson-type interferometer 29 includes a beam splitter 31 which transmits half of the incident light from the Fizeau-type interferometer 11 to a first mirror 33a, which reflects the light transmitted by the beam splitter 31 back on itself. The beam splitter 31 reflects the other half of the incident light through 90° so that the reflected part of the incident light is directed to a second mirror 33b which reflects the light reflected by the beam splitter 31 back on itself. The beam splitter 31 also reflects half of the light reflected by the first mirror 33a through 90° towards a detector 35, and transmits half of the light reflected by the second mirror 33b towards the detector 35. In this embodiment, the detector 35 is a CCD array detector having a two-dimensional array of detector elements provided a detection surface.

A path difference Δx_{M} associated with the Michelson-type interferometer 29 is given by the difference between (i) the distance travelled by light transmitted through the beam splitter 31 to the first mirror 33a and back to the beam splitter 31 and (ii) the distance travelled by light reflected by the beam splitter 31 to the second mirror 33b and back to the beam splitter 31.

With the above-described arrangement, light incident on each detector element of the detector 35 includes a portion of the sample light beam reflected from a corresponding position on the sample surface 23 and a portion of the reference light beam reflected from a corresponding position on the reference surface 21. Under certain conditions, an interference pattern is formed on a region of the detection surface of the detector 35, and the detector 35 can be said to be within an interference zone. These conditions include:
1. that the corresponding region of the sample surface substantially coincides with a wavefront of the spherical light beam 15; and
2. that the path difference Δx_{F} between the corresponding portion of the sample light beam and the corresponding portion of the reference light beam exiting the Fizeau-type interferometer arrangement 11 is compensated for by the path difference Δx_{M} associated with the Michelson-type interferometer 29.

The signal detected by each detector element of the detector 35 is output to an image processor 37, which processes the signals to form image data corresponding to the distribution of light intensity incident on the detection surface of the detector 35. This image data is output to a controller 39 which processes the image data to identify regions of the detection surface exhibiting an interference pattern. From the identified regions, the controller 39 determines the locations of regions on the sample surface 23 which coincide with a wavefront of the spherical light beam 15. In this embodiment, the controller 39 sends a control signal to the display 41 in order to output information to the user of the surface profiling apparatus.

As discussed above, a condition for an interference pattern to be formed in a region of the detection surface of the detector 35 is that the corresponding region of the sample surface 23 substantially coincides with a wavefront of the spherical light beam is. This will now be discussed in more detail with reference to FIG. 2 which shows the aspheric element 25 at two different positions along the optical axis 59 of the Fizeau-type interferometer 11, the meniscus lens 17 and a series of wavefronts 61a to 61f of the spherical light beam 15. In FIG. 2, the asphericity of the sample surface 23 has been exaggerated for ease of illustration.

As shown in FIG. 2, in this embodiment the radius of curvature of the region of the sample surface 23 of the aspheric element 25 at the optical axis 59 is larger than the radius of curvature of the region of the sample surface around the periphery of the aspheric element 25. Therefore, in a first position of the aspheric element 25, represented by the continuous lines in FIG. 2, an axial region 63 of the sample surface 23 substantially coincides with a wavefront 61d of the spherical wave 15, whereas in a second position of the aspheric element 25, represented by the dotted lines in FIG. 2, an annular region 65 of the sample surface 23 around the periphery of the aspheric element 25 substantially coincides with the wavefront 61e of the spherical wave 15. As the axial region 63 has a larger radius of curvature than the annular region 65, the first position is closer to the meniscus lens 17 than the second position.

Returning to FIG. 1, in this embodiment the aspheric element 25 is mounted on a first translation stage 43 which moves the aspheric element 25 along the optical axis 59 of the Fizeau-type interferometer 11 through a series of measurement points in accordance with drive signals from the controller 39. In this way, the controller 39 is able to move the aspheric element 25 along the optical axis 59 so that at each measurement point a different annular region of the sample surface 23 substantially coincides with a wavefront of the spherical wave 15. In particular, in this embodiment the translation stage 43 includes a coarse positioner which is used to position the aspheric element 25 in the correct vicinity, and a fine positioner which is used to scan the aspheric element 25 along the optical axis of the Fizeau-type interferometer 11. In this embodiment, the fine positioner comprises a conventional piezo-electric positioner.

The path difference Δx_{F} changes with the measurement position of the aspheric element 25 along the optical axis of the Fizeau-type interferometer 11. In order to form interference patterns for different positions of the aspheric element 25, the path difference Δx_{M} associated with the Michelson-type interferometer 29 is varied to compensate for the changes in the path difference Δx_{F}. In order to achieve this, the second mirror 33b is mounted on a second translation stage 45 whose position is controlled by drive signals from the controller 39. In the same manner as the first translation stage 43, the second translation stage 45 comprises a coarse positioner for positioning the second mirror 33b in the correct vicinity, and a fine positioner (in this embodiment a conventional piezo-electric positioner) which is used to scan the position of the second mirror 33b during a measurement.

An advantage of the arrangement described above is that both the path difference Δx_{F} associated with the Fizeau-type interferometer 11 and the path difference Δx_{M} associated with the Michelson-type interferometer 29 are air paths, i.e. they do not include transmission through any optical elements. This simplifies the information of an interference pattern because the dispersion effects which result from using a broadband light source are negligible.

The operation of the surface profiling apparatus will now be described with reference to the flow chart illustrated in FIG. 3. Initially, the positions of the aspheric element 25 and the second mirror 33b are coarsely adjusted, in step S1, by the user adjusting the coarse positioners of the first and second translation stages 43, 45 until signals characteristic of a spatial interference pattern are detected on a region of the detection surface of the detector 35. Once the aspheric element 25 and the second mirror 33b have been coarsely adjusted, the controller 39 applies, in step S3, drive signals to the fine positioners of the first and second translation stages 43, 45 until a spatial interference pattern is formed on the region of the detection surface 35 corresponding to the annulus around the outer periphery of the sample surface 23.

FIG. 4 shows how the light intensity detected by a single detector element corresponding to a region of the sample surface 23 which coincides with a wavefront of the spherical wave 15 varies as the second mirror 33b is scanned to vary Δx_{M}. In particular, the intensity variation comprises three interference patterns, a central interference pattern 71 and two side interference patterns 73a, 73b. Each interference pattern is formed by a set of interference fringes whose contrast is greatest in the centre and diminishes towards the edges.

The central interference pattern 71 corresponds to a path difference which is approximately equal to zero, and therefore the parts of the sample light beam which are transmitted and reflected by the beam splitter 31 interfere with each other, and the parts of the reference light beam which are transmitted and reflected by the beam splitter 31, interfere with each other. In contrast, the side interference patterns 73a, 73b correspond to a path difference Δx_{M} which is approximately equal to ±Δx_{F} respectively, and are caused by interference between part of the sample light beam which is directed to one of the first and second mirrors 33 and part of the reference light beam which is directed to the other of the first and second mirrors 33.

Once the interference pattern has been detected, the controller 39 scans, in step S5, the position of the second mirror 33b to vary the phase difference Δx_{M} and checks the image data produced by the image processor 37 until the edge of one of the side interference patterns 73 is detected. Then, the controller 39 scans, in step S7, the second mirror 33b by a step of approximately one hundred nanometres (i.e. approximately one eighth of the average wavelength of the light source 1) in a scan direction which leads to an increase in the contrast of the side interference pattern, and the image processor 37 generates, in step S9, image data from the signals received by the detector elements of the detector 35.

The distance the second mirror 33b is moved in each step is sufficiently small that it takes many steps to reach the other edge of the side interference pattern 73b. Therefore, after image data has been recorded and stored for a step, the controller 39 determines, in step S11, from the image data if a spatial interference pattern is still being detected. If a spatial interference pattern is still being detected, then the process returns to step S7 and the second mirror 33b is scanned by another step in the scan direction. However, if no interference pattern is detected, then the controller determines, in step S13, from the stored image data for all of the movement steps of the second mirror 33b, the profile of the region of the sample surface 23 corresponding to the spatial interference pattern. In particular, the controller identifies the position of the second mirror 33b which gives the peak fringe contrast, which corresponds to the position where the path difference Δx_{M} associated with the Michelson-type interferometer 11 is equal to the path difference Δx_{F} associated with the Fizeau-type interferometer. From the path difference Δx_{F} the controller 39 is able to calculate the profile of the region of the sample surface 23 corresponding to the interference pattern.

After determining the profile of a region of the sample surface 23, the controller 29 checks, in step S15, if the spatial interference pattern is detected by detector elements associated with the centre of the sample surface 23. If the interference pattern is not associated with the centre of the sample surface 23, the controller 39 sends, in step S17, a drive signal to the first translation stage 43 to move the aspheric element 25 a short distance along the optical axis of the Fizeau-type interferometer 11 so that a different region of the sample surface 23 coincides with a wavefront of the spherical wave 15. The process then returns to step S5. However, if the interference pattern does correspond to the centre of the sample surface 23, then the controller 39 generates, in step S19, profile data for the whole sample surface by stitching together the profile data generated for each region of the sample surface 23. In this embodiment, the stitching of the profile data employs the stitching technique described in the article “Testing aspheric surfaces using multiple annular interferograms” by M. Melozzi et al, Optical Engineering 32(5), 1073-1079 (May 1993), the whole content of which is incorporated herein by reference.

In the first embodiment, the light from the light source 1 is first directed to the Fizeau-type interferometer 11, and light exiting the Fizeau-type interferometer 11 is input to the Michelson-type interferometer 29 in order to compensate for the path difference Δx_{F} associated with the Fizeau-type interferometer. A second embodiment will now be described with reference to FIG. 5, in which components that are identical to corresponding components of the first embodiment have been referenced with the same numerals and will not be described in detail again.

As shown in FIG. 5, the low divergence light beam 7 produced by the collimating lens 5 is input directly to a Michelson-type interferometer 29, which in effect outputs two coaxial light beams having an associated path difference Δx_{M}. Half of each of the two light beams output by the Michelson-type interferometer 29 is reflected through 90° by a beam splitter 9 and directed to a Fizeau-type interferometer 11, and half of the light returned by the Fizeau-type interferometer 11 is transmitted through the beam splitter 9 and is incident on a detector 35 via a lens 81, which images the sample surface 23 onto the detection surface of the detector 35.

As in the first embodiment, the sample 25 is positioned on a translation stage 43 within the Fizeau-type interferometer arrangement 11 so that the sample surface 23 can be scanned by the controller 39 through the spherical light beam 15. Also, the second mirror 33b of the Michelson-type interferometer 29 is mounted on a second translation stage 45 so that the path difference Δx_{M} associated with the Michelson-type interferometer 29 is variable to compensate for changes in the path difference Δx_{F} associated with the Fizeau-type interferometer 11 caused by movement of the aspheric element 25.

In the first and second embodiments, the surface profiling apparatus uses a coupled-interferometer arrangement. However, this is not essential. A third embodiment will now be described with reference to FIG. 6 in which a single interferometer arrangement is used. Components shown in FIG. 6 which are identical to corresponding components of the first embodiment have been referenced by the same numerals and will not be described in detail again.

As shown in FIG. 6, the surface profiling apparatus of the third embodiment uses a Michelson-type interferometer arrangement in which approximately half of a low divergence light beam 7 produced by a broadband light source 1 is reflected through 90° by a beam splitter 91 and directed towards a first converging lens 93a, which forms a first converging spherical light beam 95a which is incident on the sample surface 3 of the aspheric element 25. The half of the light beam 7 which is transmitted through the beam splitter 91 is incident on a second converging lens 93b, which is substantially identical with the first converging lens 93a, which forms a second converging spherical light beam 95b. An optical component 97 including a reference surface 99 is positioned in the second spherical light beam 95b so that the reference surface 99 coincides with a wavefront of the spherical light beam 95b.

Part of the light of the first spherical light beam 95a is reflected back on itself by regions of the sample surface 23 which substantially coincide with a wavefront of the first spherical light beam 95a, and passes back through the first converging lens 93a which re-collimates the light and directs the light back to the beam splitter 91. Similarly, part of the light of the second spherical light beam 95b is reflected back on itself by the reference surface 99, and passes back through the second converging lens 93b which re-collimates the light and directs the light back to the beam splitter 91. The beam splitter transmits half of the incident light which has been reflected from the sample surface 23 in the direction of the detector 35, and reflects half of the light reflected by the reference surface 99 through 90° in the direction of the detector 35.

In this embodiment, the dispersion exhibited by the first and second converging lenses 93a, 93b is included in the final path length difference giving rise to the interference pattern and therefore it is important that, as in the Linnik interferometer, the two lenses 93 are a “matched pair”.

The second converging lens 93b and the optical component 97 are both mounted in fixed relation to each other on a translation stage 101, with the position of the translation stage 101 being variable in response to drive signals from the controller 39 in order to vary the path length travelled by light reflected from the reference surface 99. In particular, the controller 39 moves the translation stage 101 so that the path length travelled by light which is reflected by the reference surface 99 and then directed to the detector 35 is substantially equal to the path length travelled by light which is reflected by regions of the sample surface 23 substantially coinciding with a wavefront of the first spherical light beam 95b and directed to the detector 35, allowing an interference pattern to be formed on the detection surface of the detector 35. In other words, in this embodiment the positions of the second converging lens 93b and the optical component 97 are moved in order to compensate for any path difference between the distance travelled by light incident on the detector 35 via the sample surface 23 and light incident on the detector 35 via the reference surface 99.

### MODIFICATIONS AND FURTHER EMBODIMENTS

In the first embodiment, the sample surface being measured is the front surface of a convex aspheric element. It will be appreciated that the profile of a convex mirror having an aspheric profile could also form the sample surface. Further, as shown in FIG. 7, the profile of a concave sample surface 111 of an optical component 113 can be measured by placing the optical component 113 on the far side of the focal point 115 of the converging lens 13.

Alternatively, a concave sample surface can be measured by replacing the Fizeau-type interferometer 11 of the first embodiment with the Fizeau-type interferometer 121 shown in FIG. 8. As shown, the low-divergence light beam 7 is incident on a diverging lens 123 to form a diverging light beam 125. The diverging light beam 125 passes through a meniscus lens 127 having a front surface 129 which is anti-reflection coated and matches one wavefront of the diverging light beam 125 and a rear surface, hereafter called the reference surface 131, which matches another wavefront of the diverging light beam 125. Part of the light incident on the reference surface 131 is reflected back on itself and is re-collimated by the lens 123 to form a reference light beam, while light transmitted through the reference surface 131 is incident on a sample surface 133 of an optical component 135. Light reflected from regions of the sample surface 133 which substantially coincide with a wavefront of the spherical light beam 125 passes back though the meniscus lens and is re-collimated by the diverging lens 123 to form a sample beam. In this way, the Fizeau-type interferometer 135 outputs a sample beam and a reference beam with an associated path difference Δx_{F}.

In the described embodiments, the reference light beam and the sample light beam are formed from light reflected by an uncoated reference surface and an uncoated sample surface respectively. Alternatively, one or both of the reference surface and the sample surface could be coated to achieve a desired reflectance. In this way, the visibility of the interference pattern may be improved.

In the described embodiment, a spherical wave is formed in a Fizeau-type interferometer and an aspheric sample surface is scanned through the sample wave so that at different scan positions different regions of the sample surface coincide with a wavefront of the sample wave. Alternatively, other forms of non-uniform sample waves could be employed. For example, if the surface profile of a cylindrical asphere is to be measured, then the sample wave could be a cylindrical wave. In alternative embodiments, the sample wave has substantially parabolic wavefronts, substantially hyperbolic wavefronts and substantially ellipsoidal wavefronts respectively.

While the surface profile of an aspherical element is measured in the described embodiments, alternatively the surface profile of other optical elements could be measured, even “free-form” optical elements. If the sample surface is too large to be measured in a single measurement operation as described with reference to FIG. 3, the optical element having the sample surface can be mounted for transverse movement with respect to the direction of propagation of the sample light beam so that the surface profile can be measured in plural measurement operations with each measurement operation obtaining profile data for a different transverse region of the sample surface 23.

In the first and second embodiments, a Michelson-type interferometer is used to compensate for the path difference inherent to the Fizeau-type interferometer. It will be appreciated that other types of interferometer, for example another Fizeau-type interferometer, could be used.

In the second embodiment, a lens images the sample surface onto the detection surface of the detector. Those skilled in the art will appreciate that using such imaging allows light reflected from a point on the test surface to be efficiently guided to a point on the detection surface of the detector.

As described in the first embodiment, for each position of the sample surface 23 the second mirror is scanned in steps of approximately one-eighth of the average wavelength and the peak fringe contrast is identified. Alternatively, larger step sizes could be used in combination with sub-Nyquist sampling techniques such as those described in a paper entitled “Three-dimensional imaging by sub-Nyquist sampling of white-light interferograms” by P. de Groot and L. Deck (published in Optic Letters, Vol. 18, No. 17, 1 Sep. 1993 at pages 1462 to 1464).

In the first to third embodiments, the sample surface is mounted on a translation stage and moved through a spherical wavefront. An analogous effect can, of course, be obtained by keeping the sample surface stationary and moving the optical components associated with the generation of the spherical light beam.

Although in the previously described embodiments a controller is used to control automatically the position of the sample surface and to control automatically the path length compensation, this is not essential because an indication of the surface profile could be obtained using manually controlled adjustments.

It will be appreciated that other broadband light sources could be used instead of a superluminescent diode. For example, a white LED or a halogen lamp could be used, preferably together with a wavelength bandpass filter which limits the bandwidth of the light to increase the coherence of the light and therefore improve fringe visibility. Preferably, the FWHM spectral width of the light emitted by the light source, after filtering if required, is in the region of 2 nm to 50 nm because this corresponds to a range of coherence lengths which is short enough to prevent reflections from surfaces other than the test surface and the reference surface affecting the interference pattern.

It is also preferable that the light source approximates to a point source to enable good collimation of the emitted light beam, and accordingly good fringe visibility. In particular, if the angular subtense of the light after collimation is comparatively high, quasi-thin-film interference effects (i.e. fringe patterns caused by the different path lengths travelled by light incident on a point of the sample surface at different angles) reduce the fringe visibility. The light source subtense requirements for a Fizeau interferometer are discussed in Chapter 1 of a book entitled “Optical Shop Testing”, edited by D. Malacara, second edition, published 1992.

Those skilled in the art will appreciate that the term light includes electromagnetic waves in the ultra-violet and infra-red regions of the electromagnetic spectrum as well as the visible region. In particular a wavelength of 1.5 μm is an attractive alternative because broadband light sources and detectors have been developed for this wavelength for optical fibre communications.

1. A surface profiling apparatus for providing surface profile information for a sample surface, the surface profiling apparatus comprising:
support means for supporting a sample having a non-planar sample surface;
light directing means for directing light from a broadband light source to an interference zone along first and second light paths, the first light path including the non-planar sample surface and the second light path including a non-planar reference surface, wherein the light directing means comprises shaping means operable i) to shape the beam of light directed along the second light path to form a non-uniform reference light beam which is incident on the non-planar reference surface, wherein a wavefront of the reference non-uniform light beam substantially matches the non-planar reference surface, and ii) to shape the beam of light travelling along the first light path to form a non-uniform sample light beam which is incident on the sample surface, wherein the non-uniform sample light beam has a beam profile which substantially matches the beam profile of the non-uniform reference light beam;
moving means for causing relative movement between the sample surface and the non-uniform sample light beam; and
compensating means for compensating for a difference between the path lengths of the first and second light paths caused by relative movement between the sample surface and the sample light beam so that light from portions of the sample surface which substantially coincide with a wavefront of the sample light beam and light from corresponding portions of the reference surface produce an interference pattern in the interference zone.

2. A surface profiling apparatus according to claim 1, wherein the light directing means comprises a common path interferometer.

3. A surface profiling apparatus according to claim 2, wherein the common path interferometer comprises a Fizeau interferometer.

4. A surface profiling apparatus according to claim 1, wherein said difference between the path lengths of the first and second paths is an air path.

5. A surface profiling apparatus according to claim 1, wherein the light directing means comprises a first converging lens operable to produce a non-uniform reference light beam having part-spherical wavefronts with a common centre, and a second converging lens operable to produce a non-uniform sample light beam having part-spherical wavefronts with a common centre.

6. A surface profiling apparatus according to claim 1, wherein the light directing means comprises a meniscus lens which includes the non-planar reference surface.

7. A surface profiling apparatus according to claim 6, wherein the reference surface of the meniscus lens is separated from the sample surface by an air gap.

8. A surface profiling apparatus according to claim 1, wherein the light directing means comprises a first interferometer, and the compensating means comprises a second interferometer coupled to the first interferometer, and
wherein the second interferometer comprises means for varying the path difference associated with the second interferometer to be equal with the path difference associated with the first interferometer.

9. A surface profiling apparatus according to claim 8, wherein the second interferometer comprises a Michelson interferometer.

10. A surface profiling apparatus according to claim 8, wherein the second interferometer comprises a Fizeau interferometer.

11. A surface profiling apparatus according to claim 1, further comprising a detector for detecting the interference pattern in the interference zone.

12. A surface profiling apparatus according to claim 11, wherein the detector comprises a CCD array detector.

13. A surface profiling apparatus according to claim 11, further comprising means for controlling the moving means and the compensating means in response to the interference pattern detected by the detector.

14. A surface profiling apparatus according to claim 1, further comprising the broadband light source.

15. A surface profiling apparatus according to claim 14, wherein the broadband light source comprises a superluminescent diode.

16. A surface profiling apparatus according to claim 14, wherein the broadband light source is operable to produce light having a FWHM spectral width in the range of 2 nm to 50 nm.

17. A surface profiling apparatus according to claim 14, further comprising a bandpass filter having a bandwidth in the range of 2 nm to 50 nm for filtering light produced by the broadband light source.

18. A surface profiling apparatus for providing surface profile information for a sample surface, the surface profiling apparatus comprising:
a support operable to support a sample having a sample surface;
an optical system operable to direct light from a broadband light source to an interference zone along first and second light paths, the first light path including the sample surface and the second light path including a reference surface, wherein the optical system is operable to shape the beam of light travelling along the first light path to form a sample light beam which is incident on the sample surface, wherein the sample light beam has wavefronts which vary along the direction of propagation;
an actuator operable to cause relative movement between the sample surface and the sample light beam; and
a compensator operable to compensate for a difference between the path lengths of the first and second light paths caused by a relative movement between the sample surface and the sample light beam so that light from portions of the sample surface which substantially coincide with a wavefront of the sample light beam and light from corresponding portions of the reference surface produce an interference pattern in the interference zone.

19. A method of providing surface profile information for a sample surface, the method comprising the steps of:
directing light from a broadband light source to an interference zone along first and second light paths, the first light path including the sample surface and the second light path including a reference surface, wherein the beam of light directed along the second light path is shaped to form a non-uniform reference light beam which is incident on the non-planar reference surface, with a wavefront of the reference non-uniform light beam substantially matching the non-planar reference surface, and wherein the beam of light travelling along the first light path is shaped to form a non-uniform sample light beam which is incident on the sample surface, wherein the non-uniform sample light beam substantially matches the non-uniform reference light beam;
causing relative movement between the sample surface and the sample non-uniform light beam; and
compensating for a difference between the path lengths of the first and second light paths caused by relative movement between the sample surface and the sample light beam so that light from portions of the sample surface which substantially coincide with a wavefront of the sample light beam and light from corresponding portions of the reference surface produce an interference pattern in the interference zone.
